(19) United States
(12) Patent Application Publication
(10) Pub. No.: US 2025/0103746 A1
(43) Pub. Date: Mar. 27, 2025

(54) SYSTEM AND METHOD FOR PROVIDING A PRIVACY-AWARE PROMPT ENGINEERING SYSTEM

(71) Applicants: Gharib GHARIBI, Overland Park, KS (US); Craig GENTRY, New York, NY (US); Samuel Dov GORDON, Washington, DC (US); Nathan HO, San Francisco, CA (US); Riddhiman DAS, Parkville, MO (US)

(72) Inventors: Gharib GHARIBI, Overland Park, KS (US); Craig GENTRY, New York, NY (US); Samuel Dov GORDON, Washington, DC (US); Nathan HO, San Francisco, CA (US); Riddhiman DAS, Parkville, MO (US)

(21) Appl. No.: 18/899,600

(22) Filed: Sep. 27, 2024

Related U.S. Application Data
(60) Provisional application No. 63/540,779, filed on Sep. 27, 2023.

(51) Int. Cl. G06F 21/62

(52) U.S. Cl. CPC G06F 21/6227

(57) ABSTRACT

Systems and methods are disclosed for providing a privacy aware semantic searching system. A system can include at least one memory; and at least one processor coupled to the at least one memory and configured to receive a prompt to a target machine learning model and generate, via a semantic search machine learning model, a sensitivity score for the prompt based on a relevant of the prompt to a sensitive enterprise data. The system can use the score to redact sensitive data from the prompt. The system also can augment the prompt based on enterprise data to improve the prompt for processing by the machine leaning model. The system can include a pre-processing model for redacting and/or augmenting the prompt and a post-processing model for inserting or modifying the output of the machine learning model.

### PRIORITY CLAIM

The present application claims priority to U.S. Provisional Patent Application No. 63/540,779, filed on Sep. 27, 2023, the contents of which are incorporated herein by reference.

### TECHNICAL FIELD

The present disclosure relates to a privacy monitor that includes a pre-processing monitoring step where a user's prompt to a machine learning model is evaluated for private information and a post-processing step to evaluate for privacy issues an output of the machine learning model.

### BACKGROUND

Large language models (LLMs) have become powerful general-purpose tools that can potentially simplify natural language processing, automation of business intelligence, code development, and content generation. Currently, the quality of some proprietary LLMs is noticeably higher than the quality of open-source LLMs, and enterprises and individuals often have a strong preference for the highest quality LLMs.

However, using these LLMs presents a privacy issue, particularly when the LLMs are proprietary or are hosted in non-local cloud environments, such as OpenAI's ChatGPT. In particular, many enterprises are hesitant to allow their employees to use such LLMs because they fear that the sensitive data in their prompts to the LLM will not be kept private, thereby compromising enterprise intellectual property or customer personal identifiable information (PII). Even if a user trusts the model owner or cloud provider of the LLM, it becomes yet another possible locus of attack where the privacy of its sensitive data could be compromised.

### BRIEF SUMMARY

There is a demand for a way for users, particularly enterprises, to use proprietary or off-site LLMs, while ensuring that sensitive enterprise information remains secure, unavailable to the LLM owner, cloud providers, or potential attackers to be stored, analyzed or misused.

This disclosure introduces a system and method that can provide a privacy monitor, a comprehensive system designed to manage the privacy risks associated with prompting any machine learning model such as, for example, large language models (LLMs) like ChatGPT. The system in some aspects operates in two main steps: pre-processing and post-processing.

During pre-processing, the privacy monitor assesses the sensitivity of a user's prompt for private information, including personally identifiable information (PII) and proprietary enterprise data. It employs machine learning algorithms to automatically redact sensitive terms before transmitting the prompt to the machine learning model. Another aspect, called the “sandwich approach,” incorporates two additional models (PM1 and PM2) that wrap around the machine learning model to fine-tune privacy and coherence. For example, post-processing can involve re-introducing redacted terms into the machine learning model's response to ensure context maintenance.

The system also can offer semantic search capabilities that score a prompt's privacy risk based on similarity to sensitive enterprise data. An integrated approach merges this privacy-aware system with prompt engineering methods to link user prompts to relevant enterprise documents, improving the machine learning model output relevance without model fine-tuning. The semantic search capabilities can be used to redact a prompt or even augment a prompt to make it more relevant and likely to generate the desired output from the machine learning model. The multi-faceted system leverages machine learning, semantic search, and human-in-the-loop feedback to maximize utility while minimizing data leakage risks. Note that the “system” can include any one or more of the various components described above.

A first summary is directed to an automated detection and redaction approach for sensitive information. In some aspects, the techniques described herein relate to a method of managing information provided to a machine learning model, the method including: receiving a prompt having sensitive information, the prompt being received for input to a machine learning model; identifying the sensitive information in the prompt; redacting the sensitive information in the prompt to obtain a redacted prompt having redacted information removed from the prompt; and transmitting the redacted prompt to the machine learning model.

In some aspects, the techniques described herein relate to a system for managing prompts to a machine learning model, the system including: at least one memory; and at least one processor coupled to the at least one memory and configured to: receive a prompt having sensitive information, the prompt being received for input to a machine learning model; identify the sensitive information in the prompt; redact the sensitive information in the prompt to obtain a redacted prompt having redacted information removed from the prompt; and transmit the redacted prompt to the machine learning model.

In some aspects, the techniques described herein relate to a non-transitory computer-readable medium having stored thereon instructions that, when executed by one or more processors, cause the one or more processors to: receive a prompt having sensitive information, the prompt being received for input to a machine learning model; identify the sensitive information in the prompt; redact the sensitive information in the prompt to obtain a redacted prompt having redacted information removed from the prompt; and transmit the redacted prompt to the machine learning model.

A second summary is directed to privacy-aware prompting using a sandwich approach. In some aspects, the techniques described herein relate to a method of providing privacy-aware prompting to a machine learning model, the method including: implementing a pre-processing model to the machine learning model that processes a prompt to the machine learning model for privacy-related information; and implementing a post-processing model that processes an output from the machine learning model.

In some aspects, the techniques described herein relate to a system for offering a secure model as a service, the system including: at least one memory; and at least one processor coupled to the at least one memory and configured to: implement a pre-processing model to a target machine learning model that processes a prompt to the target machine learning model for privacy-related information; and implement a post-processing model that processes an output from the machine learning model.

In some aspects, the techniques described herein relate to a non-transitory computer-readable medium having stored thereon instructions that, when executed by one or more processors, cause the one or more processors to: implement a pre-processing model to a target machine learning model that processes a prompt to the target machine learning model for privacy-related information; and implement a post-processing model that processes an output from the machine learning model.

A third summary is directed to privacy-aware prompting using semantic search and enterprise information. In some aspects, the techniques described herein relate to a method of providing privacy-aware semantic searching, the method including: receiving a prompt to a target machine learning model; and generating, via a semantic search machine learning model, a sensitivity score for the prompt based on a relevant of the prompt to a sensitive enterprise data.

In some aspects, the techniques described herein relate to a system for offering a secure model as a service, the system including: at least one memory; and at least one processor coupled to the at least one memory and configured to: receive a prompt to a target machine learning model; and generate, via a semantic search machine learning model, a sensitivity score for the prompt based on a relevant of the prompt to a sensitive enterprise data.

In some aspects, the techniques described herein relate to a non-transitory computer-readable medium having stored thereon instructions that, when executed by one or more processor, cause the one or more processor to: receive a prompt to a target machine learning model; and generate, via a semantic search machine learning model, a sensitivity score for the prompt based on a relevant of the prompt to a sensitive enterprise data.

A fourth summary is directed to a combined approach in which one or more of the above approaches are combined together. In some aspects, the techniques described herein relate to a method of providing an augmented, redacted prompt to a machine learning model, the method including: receiving a prompt to a target machine learning model; identifying sensitive information in the prompt; redacting the sensitive information in the prompt; augmenting, via a semantic search-based retrieval model, the prompt with relevant enterprise data to generate a redacted and augmented prompt; and providing the redacted and augmented prompt to the target machine learning model.

In some aspects, the techniques described herein relate to a system for offering a secure model as a service, the system including: at least one memory; and at least one processor coupled to the at least one memory and configured to: receive a prompt to a target machine learning model; identify sensitive information in the prompt; redact the sensitive information in the prompt; augment, via a semantic search-based retrieval model, the prompt with relevant enterprise data to generate a redacted and augmented prompt; and provide the redacted and augmented prompt to the target machine learning model.

In some aspects, the techniques described herein relate to a non-transitory computer-readable medium having stored thereon instructions that, when executed by one or more processor, cause the one or more processor to: receive a prompt to a target machine learning model; identify sensitive information in the prompt; redact the sensitive information in the prompt; augment, via a semantic search-based retrieval model, the prompt with relevant enterprise data to generate a redacted and augmented prompt; and provide the redacted and augmented prompt to the target machine learning model.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an architecture for privacy-aware prompting with semantic search, according to some aspects of this disclosure;

FIG. 2 illustrates an overview of various privacy monitor components, according to some aspects of this disclosure;

FIG. 3A illustrates an example method related to an automated detection and redaction approach for sensitive information, according to some aspects of this disclosure;

FIG. 3B illustrates an example method related to privacy-aware prompting using a sandwich approach, according to some aspects of this disclosure;

FIG. 3C illustrates an example method related to privacy-aware prompting using semantic search and enterprise information, according to some aspects of this disclosure;

FIG. 3D illustrates an example method related to a combined approach in which one or more of the above approaches are combined together, according to some aspects of this disclosure; and

FIG. 4 shows an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Consider a machine learning model, typically an LLM, and a user that wants to send the model a prompt (an input, such as a question) and to receive a response from the LLM. Often, both the model owner and the user have privacy concerns. The model may be considered to be proprietary and include intellectual proprietary (IP). For example, it may have been trained on a private dataset, or the owner may have invested in an expensive training process. The user's prompt may also be private. For example, the user may be asking a question with PII or enterprise IP. If either the model or the prompt is not private, the privacy issue of the other part is typically easily resolved. If the model is private but the prompt is not, the user can simply send its prompt to the model owner for evaluation. The prompt may be private but the model may not be private. For example, if the model is open-source, then the user may be able to download the model locally so that it can evaluate its prompt in the privacy of its own environment. For privacy, the difficulty arises when both the model and the prompt are private.

This disclosure introduces various solutions to these and other issues. There are a number of different categories of solutions. For example, one category of solution is an automated detection and redaction of sensitive information. Another category relates to privacy-aware prompting using a sandwich approach in which a pre-processing model redacts a prompt and a post-processing model augments the output of the machine learning model to generate a comprehensive response. Another category relates to privacy-aware prompting using semantic search which involves machine learning to score and process the prompt based on its relevance to sensitive enterprise data. This process may include redacting a prompt but could also include augmenting a prompt to make it more robust relative to the machine learning model to improve the output. A fourth category can include a combined approach of one or more of the methods disclosed herein. For example, a prompt could be both redacted relative to private information and augmented to improve the prompt for processing by the machine learning model, and then the output of the model might be augmented for consistency with the prompt such as inserting previously-redacted private terms.

While LLMs are discussed in the context of this disclosure, the principles herein can be applicable to any type of machine learning model. For example, generative machine learning models may generate images based on text input. The “output” of such a model, being an image, could still be augmented with image features perhaps added that were redacted from the text input. Machine learning models that receive images and output a classification of the image (such as a medical image with an output predicting a cancerous growth) could also be processed in a similar manner as disclosed herein for LLMs.

Consider a few possible approaches when both the model and the prompt are private. Secure Multi-Party Computation (SMPC). SMPC secures a computation using cryptography. Basic cryptography secures data at rest and in transit. SMPC, which includes various techniques such as homomorphic encryption, secures data during computation. In general, any computation that can be performed on a computer in a feasible amount of time (polynomial-time computations) can be evaluated securely using SMPC, with security that is either perfect based on the assumption that lower than a threshold number of parties in the computation collude to break security, or with security that is based on computation assumptions, such as the assumed hardness of factoring large integers.

An issue with SMPC is that it introduces overhead to the computation. The overhead can include either computational overhead, or the overhead of communication among the participating parties. Many SMPC protocols have many rounds of communication among the parties, allowing network latency to have a big effect. Homomorphic encryption does not have these rounds of communication, but the computational overhead of operating on data in encrypted form can be very high.

Evaluating LLMs at scale is already at the edge of feasibility before one can introduce securing the evaluation with SMPC. There have been some efforts to evaluate LLMs using SMPC recent work on SMPC inference for Llama-7B. The process takes five minutes to generate one token, which is impractical for real-world applications.

One aspect of this disclosure relates to model hosting in secure enclaves. Currently, model owners such as OpenAI offer a service where their model is hosted on a cloud provider, such as Microsoft Azure, and available to users (such as enterprises) for prompting and finetuning of private enterprise data, with assurances that prompts and finetuning data will not be used by the model owner in unpermitted ways, such as to update its model. However, these assurances are not enforced technologically, as the customer is provided no means of verifying that its data is handled properly.

Secure enclaves (trusted execution environments) are a hardware-based technology designed to allow isolation and attestation: isolation of code and data in a secure environment, and attestation of the state of a chip or virtual machine to provide assurance about the integrity and the origin of computations that are allowed to be performed. Isolation can help ensure that even external entities with high privileges, such as an operating system, will not have undue access to or influence on a computation. Attestation can help ensure that only allowed computations are run on the machine.

However, enclaves are designed more for the scenario of allowing a user to run a virtual machine that it manages within a platform that is owned by an entity that is not fully trusted. It is designed less for the scenario of private collaborative computation, where two parties—in our case, a model owner and a user—want to bring their inputs together for a computation in which neither party has the power to learn anything that they shouldn't. In particular, in the typical enclave setting, one party will have control over the enclave instance, and will be relatively unconstrained in the modifications to it that it is allowed to make. Adapting secure enclaves for the scenario of collaborative computation, where no single party is trusted to control the enclave, requires nontrivial modifications and is a component of one embodiment of this disclosure.

An aspect of this disclosure is redaction. One simple way to address the privacy of the prompt is redaction, such as redaction of private health information (i.e., PHI) as classified by HIPAA. The redaction could be performed by some sort of a classification model, which could be a model trained to identify PHI or PII terms in a prompt and remove them to obtain a redacted prompt that is input to the machine learning model. The machine learning model processes the redacted prompt and generates output or a response. In the prompt or as metadata connected or associated with the prompt, the model can be given instructions on how to deal with the redacted information, including how to format its response. Upon receiving the response, redacted information can be re-introduced by a post-processing model before sending the final response to the user.

Redaction might be an imperfect solution. It has been said: “Anonymized Data Isn't”. This is mainly because privacy is contextual. Simple removal of terms that are manifestly PII may preserve contextual information that compromises privacy completely. Hence, in addition to the disclosed automated redaction technique introduced as part of this invention, the system can improve upon this simple redaction solution in two ways. First, by constructing a privacy monitor that understands privacy contextually, and describing how to construct it by training a neural network consisting of three particular sub-networks. Second, by using a combination of prompt engineering, semantic search, and semantic verification to ensure a strong, useful, explainable, non-hallucinatory responses.

In some aspect, this disclosure provides for model finetuning and differential privacy. Model finetuning and differential privacy are not, by themselves, a means of dealing with privately prompting a private model, but they help provide useful context for this disclosure. Model finetuning is an extension of the model training. A pre-trained model (also known as a foundation model) is an initial model trained on a large body of text, such as the open-source model Llama-2 or GPT-4. The pre-trained model may be finetuned on an additional data to perform a specialized task, which may be private enterprise data. When the pre-trained model is public, the user can download it and finetune it locally on its private data. When both the model and the auxiliary training data are private, we are in a similar situation to private model and private prompt.

Differential privacy ensures the distribution of an output of an algorithm. For example, model training or finetuning does not depend “too much” on any particular sample in the training data. This property ensures that the final result (for example, the model) does not “leak” the data on which it was trained. Differentially private stochastic gradient descent (DP-SGD) is a method to train, or finetune, a model in a differentially private way. Training a LLM de novo using differentially private techniques has been shown to not work very well. Instead, the pre-trained model is typically trained on “public” data, and then optionally DP-SGD can be used to finetune the model on a private dataset. DP-SGD ensures that the final model does not “leak” private data samples used during finetuning, while it provides no security guarantee about the training data used in the initial training.

Finetuning a private model with private data presents the same problems as prompting a private model with a private prompt, but with the difficulty magnified: finetuning is a much more computationally intensive process than processing a single prompt. Current solutions for this problem are inadequate—e.g., some model owners provide a hosted solution with unverifiable security assurances.

The relevance to this disclosure is that prompt engineering can be used as a kind of “poor man's” finetuning. A prompt can be supplemented with training samples that act as instructions to process the prompt. The solution will use a combination of embedding-based semantic search and privacy monitoring tools to bring in relevant supplementary (e.g., enterprise) information into a prompt, but in a privacy preserving way. So, in addition to presenting a method for privacy-preserving prompting, this disclosure also provides a partial solution to the problem of privately finetuning a private model.

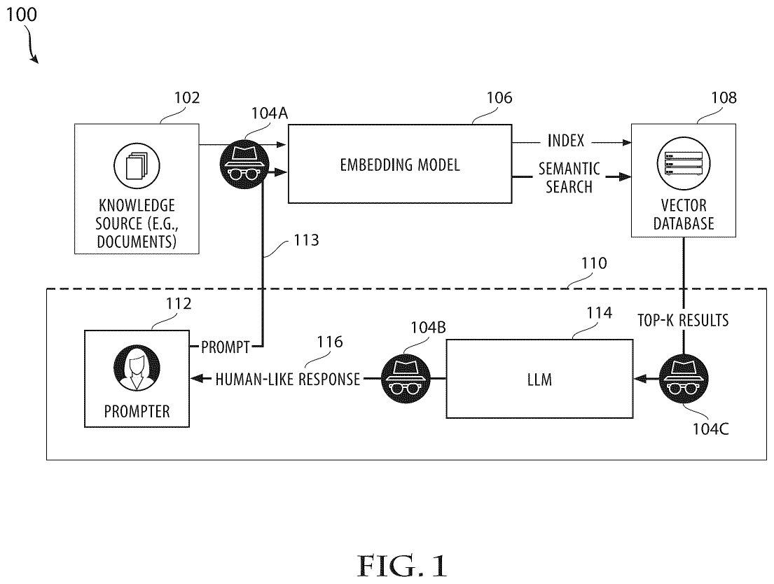

This disclosure introduces a privacy-aware prompt engineering system which can be called a privacy monitor, that addresses the aforementioned challenges. FIG. 1 illustrates an example privacy monitor architecture 100. The privacy monitor architecture 100 involves two main steps: a pre-processing step in which a first privacy monitor 104A is applied to a prompt 113 generated by a prompter 112 before sending it to the LLM 114, and a post-processing step in which a second privacy monitor 104B applied to the LLM's response. The first privacy monitor 104A can access a knowledge source 102 when semantic search is involved in the process. An embedding model 106 can be used to index and provide results of a semantic search to a vector database 108 which can generate a top-k number of results and process them through a third privacy monitor 104C for submission to the LLM 114 to generate a response, which also can be processed as noted above by the second privacy monitor 104B to obtain a human-like response such as response 116.

The use of the knowledge source 102, the embedding model 106 and the vector database 108 are described in more detail below related to the privacy-aware prompting using semantic search aspect of this disclosure. An overall “privacy monitor” can include any one or more of these subcomponents such as the first privacy monitor 104A, the second privacy monitor 104B and/or the third privacy monitor 104C as well as other components such as the knowledge source 102.

Often, the pre-processing step involves assessing the sensitivity of the prompt (e.g., the presence of PII or enterprise IP). The same pattern can be extended to other applications, such as detecting hate speech and jailbreak attempts. Finally, based on the downstream task and the sensitivity of the prompt, the system provides redaction, information reduction, augmentation of the prompt, and notification capabilities. This disclosure employs a multi-faceted approach, combining machine learning models, semantic search capabilities in which a knowledge source 102 can be accessed, and human-in-the-loop feedback mechanisms to dynamically assess the risk of data leakage from the user prompts, and treating them accordingly. The disclosed privacy monitor encompasses several techniques and various combination of the techniques as well.

In a first aspect, the privacy monitor can include automated detection and redaction of sensitive information. A system automatically detects and redacts PII, PHI, and custom private categories (i.e., user defined categories of private information) from the prompt via a first privacy monitor 104A before sending it to the LLM 114. Once processed by the LLM 114, the system via for example a second privacy monitor 104B can represent a number of different functions. For example, the second privacy monitor 104B can process the output of the LLM 114 for redacting private information that is found in the generated response. The second privacy monitor 104B can also be sued to re-introduce the redacted terms in the response. Note that some of these operations may also be incorporated into the LLM 114 or these functions may be separated into separate components. Another embodiment of this approach includes additional detection and filtration algorithms, such as classifiers and topic modeling algorithms, to detect additional categories, such as hate speech, sexual content, or model jailbreak.

In a second aspect, privacy-aware prompting using the sandwich can be implemented. This aspect introduces a more sophisticated technique within the privacy monitor that encompasses two models (a first privacy monitor 104A and a second privacy monitor 104B) wrapping the target LLM (e.g., ChatGPT or Llama-2). The first privacy monitor 104A, closer to the input, is a pre-processing model, which aims to reduce sensitive information in the prompt while maintain its meaning, before sending it to the LLM 114. The first privacy monitor 104A (which can also be called PM1) can include a skip connection to the second privacy monitor 104B (which can be called PM2) and/or the third privacy monitor 104C, which receives the outputs of the LLM 114 and the first privacy monitor 104A and post-process them into a comprehensive response. The skip connection can essentially include a connection between the pre-processing model and the post-processing model that enables data to be shared while avoiding the machine learning model or with no mechanism for the machine learning model to gain access to the communicated data.

In a third aspect, the privacy monitor can include privacy-aware prompting using semantic search. A system for private, embedding-based, semantic-search retrieval can be implemented. The system involves training a machine learning model to score the prompt's privacy according to the sensitivity of the most related enterprise data such as the knowledge source 102. It can be implemented as a stand-alone system or in a combination with embedding-based semantic search applications.

In a fourth aspect, various combinations of the above three aspects can be implemented. One can introduce a prompt engineering system that improves the user prompt by, among other things, connecting a user's prompt with relevant enterprise documents or a knowledge source 102. But then one needs the privacy monitor to process the user's augmented prompt (including the document excerpts) to remove sensitive information. This combined approach results in a strong prompt engineering system that makes the model's response relevant to enterprise data without the complex process of model finetuning, while minimally disclosing sensitive enterprise information, and while improving explainability and defending against hallucinations in the model response.

Further details of the above four approaches is provided next. The first aspect of automated detection and redaction of sensitive Information in the system involves pre-processing the prompt to remove the sensitive information and send the sanitized prompt to the LLM 114. The model owner will not see the sensitive information, but the LLM 114 will still produce a useful response. The response can then be post-processed via the second privacy monitor 104B to add the sensitive information back in for the prompter.

The pre-processing step utilizes a combination of machine learning models and regex expressions to identify sensitive information in the prompt. The problem has, to some extent, been studied as Named Entity Recognition (NER) in the field of natural language processing. One can utilize different types of machine learning models, or an ensemble of them, to address this problem. For example, one can perform this task using a transformer-encoder architecture with the head of the neural network performing classification per token. LLMs also use transformer architectures but they perform the task of next token prediction rather than token classification. The automated redaction approach involves the following steps:

Step 1 involves detecting sensitive information. A model and/or an ensemble of models can be generated as proprietary models and/or open-source models (such as Microsoft Presidio), that are capable of classifying named entities into over thirty categories of sensitive information (e.g., name, age, IP address, gender, etc.). At their core, these models accept a user prompt or any other text and produce probability distribution for each token, indicating its likelihood of belonging to a specific category of sensitive information. For example, the model would classify “John” as a “Person” and “New York” as a “Location” in the phrase “John lives in New York”.

In addition to the model ensemble, the system utilizes a set of regular expressions (regex) tailored to identify structured data formats such as email addresses, phone numbers, social security numbers (SSNs), and credit card details. For example, the regex pattern “\d{3}-\d{2}-\d{4}” can be used to identify typical SSN formats like “123-45-6789”. A holistic approach is employed by applying all the token classification models and regex patterns to the input prompt. Prioritizing privacy, any section of the text identified as potentially sensitive is detected.

The redaction capability, in addition to using classification models and regex, is further enhanced with a capability to allow the user to define new categories of sensitive information to be detected and redacted as well. One can call this capability or implemented this capability through redaction templates. For example, the user can define their own regex expressions or black-list certain names or pieces of information. A user interface to the LLM 114 can be generated that enables a user to input data for a redaction template that can be used for one prompt or a series of prompts or for a specific group of people.

Step 2 involves creating mapping dictionaries. The system includes a dictionary that maps every term (or token) classified as sensitive information to a placeholder or token. For example, “John” will be mapped to “Name_1” and “New York” will be mapped to “Location_1”. This dictionary enables the separation of different named entities in the prompt to maintain their context and facilitate re-introduction of the redacted terms in the post-processing step via the second privacy monitor 104B. The term “dictionaries” here refers to any structure that enables such mapping, including Python dictionaries, for example.

Step 3 involves the use of redaction templates. The model ensemble and regex expressions aim to detect all sensitive information in the prompt. However, there are cases where the user prefers not to redact some sensitive information that is critical to generate a meaningful response from the LLM—e.g., while the patient's name and address should be redacted automatically, information about used drugs are essential when prompting about the drug's side effects. In such scenarios, the privacy monitor enables the user to define certain templates that configure what to redact and what not to redact. Once one redacts all sensitive terms based on the outputs of Step 1 and redaction templates, the redacted prompt is sent to the LLM 114.

Step 4 involves re-identification. After receiving the prompt's response from the LLM 114, the privacy monitor re-introduce the redacted information to provide a comprehensive response to the prompter. In an additional implementation, the generated response also goes through a privacy monitor such as the second privacy monitor 104B that detects any sensitive information that should not be shared with the prompter and redacts it before sending the response. One preferred embodiment to implement this feature is by using role-based access control systems (RBAC).

Next is discussed in more detail privacy-aware prompting using the sandwich approach. While redaction and re-introduction of sensitive terms has the appeal of simplicity, the second technique used in the privacy monitor includes the following principles. A neural network can be constructed as three sub-networks stacked on top of each other. The middle network is an LLM 114, such as GPT-4 or LLaMa-2. The first network (closer to the input) is the prompt pre-processing component of the privacy monitor and can include the first privacy monitor 104A or PM1. The third network (closer to the output) is the LLM response post-processing component of the privacy monitor or the second privacy monitor 104B or PM2. There are skip connections from PM1 to PM2 that bypass the LLM 114 in the middle to allow PM1 to pass some information directly to PM2. In the simplest case, PM1 simply passes portions of the raw prompt to PM2. Altogether, this network takes a raw prompt that potentially contains sensitive information as input, and processes it to produce a response, according to the function: response=PM2 (randomness, Ext Model [PM1 (randomness, raw_prompt)]).

While training and finetuning the privacy monitor (PM1, PM2), there are two objectives. First, the PM1 should minimize sensitive information sent to the external model ext-model. The overall network PM2 (randomness, ext-model [PM1 (randomness, raw_prompt)]) should have a distribution that is as similar as possible (consistent with the first objective) to the distribution of the ext-model [raw_prompt].

Simply, the network should behave like the external model, but without actually having to send sensitive information to the external model. Of course, redaction and re-introduction of sensitive terms is one thing (PM1, PM2) may end up doing, but the pre-processing and post-processing could be much more sophisticated than this in general.

One way to train and finetune (PM1, PM2) is as follows. One can generate training data as input-output pairs from a LLM 114, where the inputs are raw prompts containing sensitive data. Since this data is sensitive, it is preferred to use an open-source model locally, to ensure security. Later, one may replace the LLM 114 in the middle with a different, possibly proprietary model, with the expectation that the performance of our overall network will be mostly preserved. With training data in hand, one can freeze the weights of the inner LLM, and train/finetune the weights of PM1 and PM2 so as to simultaneously have PM1's output be privacy-preserving, and the overall network to have good accuracy relative to the (input, output) pairs.

Because the inputs and outputs of the LLM 114 will be words (as opposed to, say, vector embeddings), the output of PM1 and input of PM2 will also be words. Having access to the embeddings to the inner LLM may help improve the performance of the technique. Next, accuracy will be defined in terms of how well ext-model(·) and PM2 (randomness, ext-model [PM1 (randomness,·)]) agree on the next token. If the system has access to probabilities for the next token in the ext-model, as opposed to just the chosen token again this may improve the performance of the technique. Further, it is a challenging problem to select a good measure of privacy loss for the output of PM1. Two preferred embodiments that we introduce here for measuring privacy loss in the context of this approach are: 1) use a redactor model, which identifies various types of PII, or 2) apply a “decorrelation” measure that measures how decorrelated PM1's output is from the raw prompt in terms of standard statistical metrics. For example, a bi-directional long short-term memory (LSTM), or a transformer-based architecture, can be trained on a dataset with PII information for sequence tagging. In the case of using PM1 as a decorrelation model, one can utilize different metrics, such as mutual information (MI) or correlation coefficients, to quantify how well the output of PM1 has been stripped of information that can be linked back to the original prompt. Later in this specification, we discuss more sophisticated embodiments for the privacy measure aspect of this invention that measure privacy contextually based on a user's or enterprises data.

Another possible interpretation of this structure of models can be applied to detect hate speech or LLM jailbreak attempts by PM1 (before sending the prompt to the LLM 114) or by PM2 (before sending the response to the user). For example, given a proprietary LLM, PM1 can be used to detect adversarial prompts sent to this LLM 114. Similarly, PM2 can be used to detect any sensitive information, generated by the LLM 114, that should not be revealed to the prompter.

To enhance the model's factual recall abilities, in-context learning is frequently used by augmenting the prompt with additional knowledge. This aspect can be called privacy-aware prompting using semantic search. For example, when prompting about the side effects of a drug on a specific patient, the doctor can include the patient's complete medical record in the prompt in order to get an accurate response. While this method works well, it is mainly limited by the context length (input size) of the LLM 114. For example, Llama-2 has a context length of 4096 tokens. Thus, most medical records will exceed the model's maximum input size. Even when the underlying model has a large context length, including documents in every prompt can quickly become very expensive. The “expense” can be cost-wise when using third-party LLMs or computationally when using self-hosted LLMs.

To address the aforementioned challenges, and to produce specialized, explainable, and non-hallucinatory responses from LLMs, one can utilize embedding-based, semantic search retrieval (also known as retrieval based generation). This process includes two steps: first, given a query or prompt, relevant information is retrieved from a knowledge source 102, such as the user's (e.g., enterprise) knowledge source, a database or set of documents. Second, the retrieved information is used to augment the generation process of the LLM 114. This involves essentially providing the LLM 114 with real-time, context-rich data in addition to the prompt.

As shown in FIG. 1, the process can include several phases. Phase 1: Prepare search data (knowledge sources). This phase is often performed offline and once per knowledge source. This phase includes the following operations: Collect: Identify all data sources relevant to the downstream task; Chunk: Split the data into smaller, self-contained sections; Embed: Create embeddings of the data chunks using an embedding model 106; Store: Index the embeddings and relevant data chunks in a database (e.g., a vector database 108).

Phase 2: Answer prompts. This phase is performed online when the user prompts the system: Embed: Convert the user prompt to an embedding using the same model (i.e., the embedding model 106) used for embedding the data sources in Phase 1; Search: Use a similarity metric, often cosine similarity, to retrieve the k data chunks in the data source that are most relevant to the user query; Answer the prompt: Send the most relevant data chunks along with the user prompt to the LLM 114, and obtain a response.

Based on the downstream task and user preference, the disclosed implementation supports different aspects for the system, including different types of knowledge sources (including external sources and APIs), databases, and open source and proprietary models for embedding (depicted as the embedding model 106) and for prompting such as the LLM 114.

Privacy-aware prompting using semantic search extends the straightforward redaction technique to a more sophisticated method that focuses on identifying the sensitivity of the prompt based on the context and inclusion of any information deemed private or IP to the user or enterprise.

Specifically, it utilizes machine learning models trained on the organization's repository of documents, images, and code to assign sensitivity scores to these assets. These scores serve as a benchmark for real-time monitoring of users' inputs to the LLM 114. By conducting semantic searches within a secured vector database of these assets, the system dynamically identifies potential data leakage risks and notifies the user, offering different levels of alerts based on the assessed sensitivity. Additional features include human-in-the-loop feedback mechanisms, context-based sensitivity adjustments, and continuous learning capabilities to adapt to the evolving nature of what is considered sensitive within the enterprise.

Next is described the different components and general workflow of the system. The first step is data collection: the first step involves indicating the corpus of the enterprise data, which may include various types of files like documents, code repositories, images, and other data types. Particular directories may be indexed by user supervision for their heightened privacy (sensitivity), such as a “Patents” directory, which typically include enterprise IP.

The second step is model training. A machine learning model is trained on this corpus to predict sensitivity scores. One possible way to train such a model is by using a conventional supervised learning approach, which requires the enterprise to first provide ground truth to the collected corpus as sensitivity scores. Another preferred embodiment utilizes a hybrid approach in which an autoregressive language model (self-supervised) is employed alongside other machine learning classifiers to assess and assign sensitivity scores to the data. Once such a model is trained, its behavior and performance can be further improved using human supervision by applying RLHF (Reinforcement Learning from Human Feedback) on the trained model.

The third step is real-time sensitivity assessment. This step involves scoring the prompts on their sensitivity can be achieved in several ways.

In some aspects, the scoring can be done via direct model inference. When the user types a prompt into a third-party LLM through the system, it is forwarded to a trained model to assess its sensitivity. Based on the predicted score, different actions will be taken. For example, low scores indicate that the prompt doesn't include any sensitive information and can be sent directly to the LLM 114. High sensitivity scores indicate that the prompt includes sensitive data that requires attention from the user or can possibly notify and require a managerial approval before submitting the prompt to the LLM 114, based on the enterprise rules (or regulations).

In some aspects, the scoring can be done through semantic search inference. The privacy monitor attaches sensitivity scores to each indexed embedding and document in the vector database. In this scenario, when a user inputs a prompt into a third-party LLM (i.e., the LLM 114), the system first performs a semantic search within the vector database 108 to retrieve the related documents along with their sensitivity scores. When multiple documents are retrieved with different sensitivity scores, the system considers the highest sensitivity score among them to provide tighter privacy guarantees. For prompts that do not require semantic search, privacy assessment can be performed by comparing the prompt to the vector database 108 and scoring its sensitivity based on the sensitivity of the most related documents.

In some aspects, the scoring can be done using retrieval-augmented model inference. The two approaches above are combined in which semantic search is used to pull prompt-relevant documents and their sensitivity scores, which a trained retrieval-augmented model uses to produce a final score and take appropriate action.

In some aspects, the scoring can be done dynamic alerting. An alert, ranging from a simple notification to a need for managerial approval, is issued to the user based on the assessed sensitivity score of the prompt.

In some aspects, the process can include human-in-the-loop feedback. Users have the ability to adjust the sensitivity scores of prompts. This feedback loop allows for continuous model refinement and requires managerial approval. The system is designed to continually update its model and reevaluate the sensitivity of the scored documents, incorporating mechanisms like RLHF to adapt to evolving enterprise needs.

In some aspects, the process can include prompt forwarding. Once the prompt has been assessed for sensitivity and any necessary alerts and changes have been issued (i.e., via the third privacy monitor 104C), it is then forwarded to the LLM 114 for processing.

In a further aspect of this disclosure, the user's query is evaluated against the enterprise's Role-Based Access Control System (RBAC) prior to its evaluation against the vector database 108, ensuring that users are prevented from making prompts concerning files and records for which they lack authorization.

In other aspects, where the LLM 114 is potentially fine-tuned on enterprise data, the system extends its sensitivity analysis to the output generated by the LLM 114. Once the LLM 114 produces a response, it is processed in a manner similar to the input prompt. The system can use both the second privacy monitor 104B and/or RBAC at this stage to verify whether the user has the appropriate authorization to access the identified sensitive information.

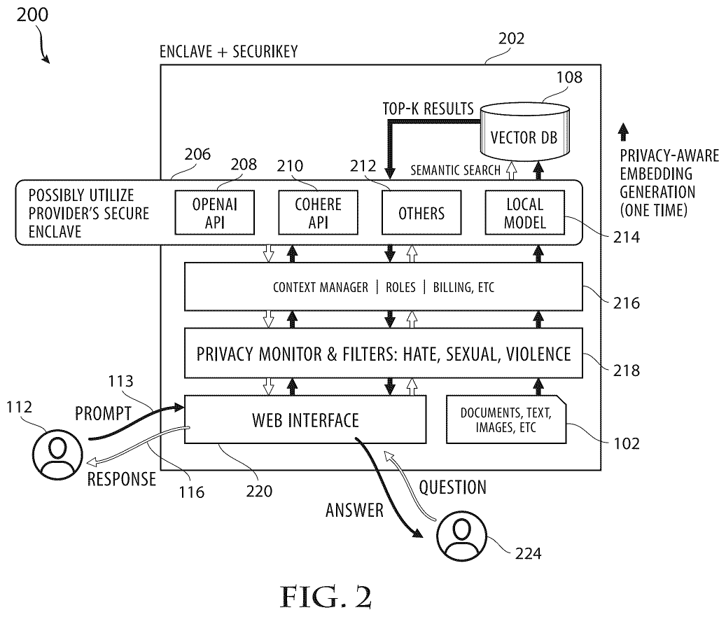

FIG. 2 illustrates an architecture overview 200 of a privacy monitoring system. The enclave plus SecuriKey 202 represents different types of trusted execution environments. SecuriKey is a key management system that can use secure multiparty calculations (SMPC) to manage keys. A user 224 may ask a question at a web interface 220. The question can be processed by a privacy monitor and filter component 218 which can detect or filter hate speech, sexual content, violent content etc. A knowledge source 102 can include documents, text, images, for example in association with an enterprise. A context manager 216 can identify context such as rolls, billing and so for the data. The question can be passed to a model layer 214 that can include application programming interfaces (APIs) to OpenAI, Cohere API, access to a local model or other models to generate a semantic search to a vector database 108. The top-k results can be provided back through the various layers to provide an answer to the user 224. Similarly a prompt 113 from a user 112 via the web interface 220 can be provided to a model such as an LLM 114. The same process through the enclave plus SecuriKey 202 can be used to obtain the response 116 from the LLM 114. FIG. 2 illustrates an example execution environment in a secure enclave.

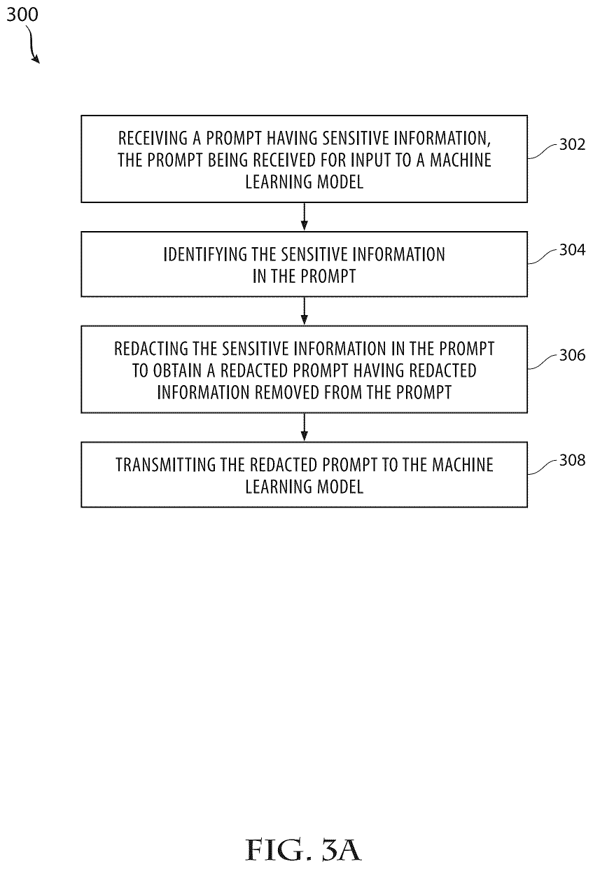

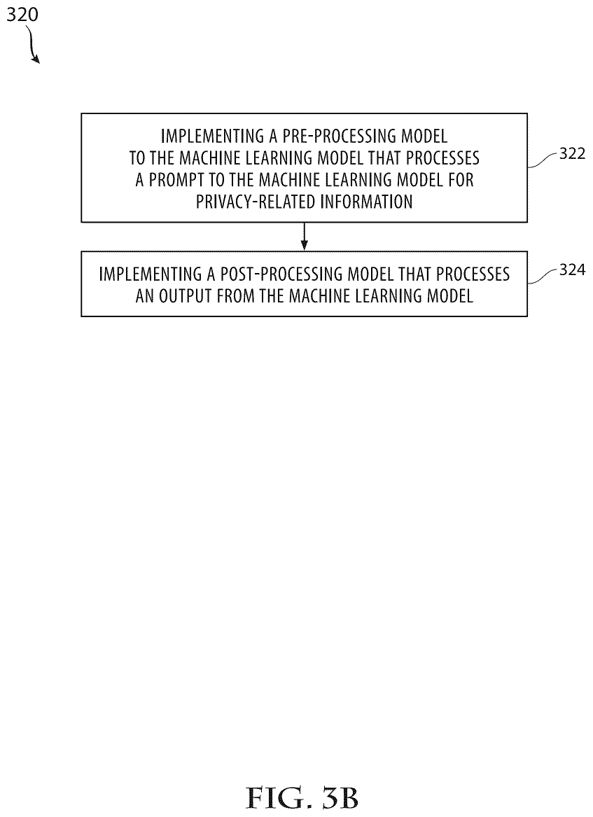

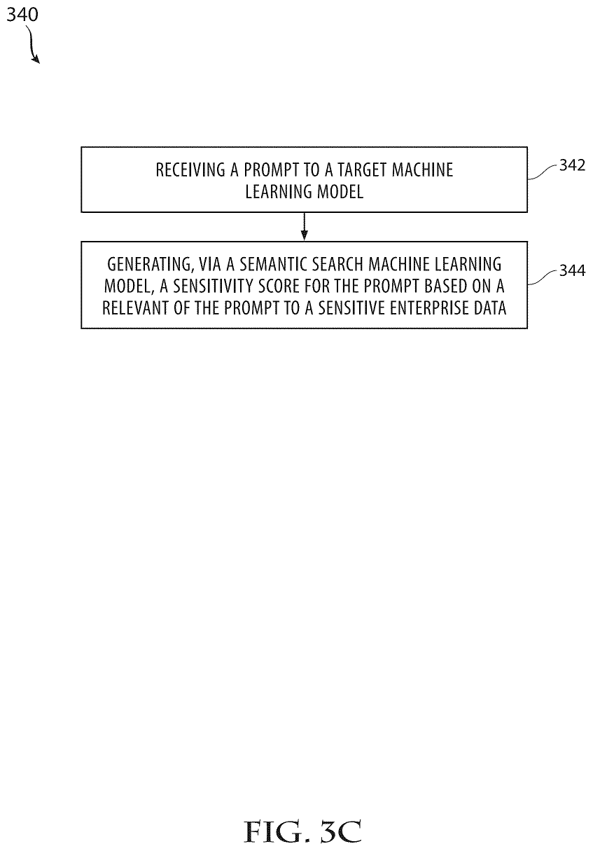

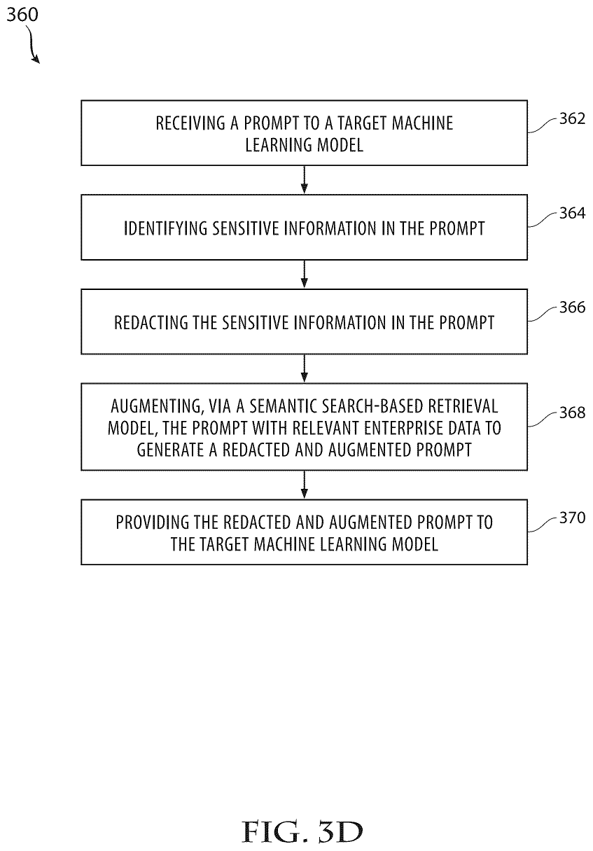

FIG. 3A illustrates a method 300 according to certain aspects of this disclosure. The method can be practiced by a system or computing system such one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof.

At block 302, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to receive a prompt having sensitive information, the prompt being received for input to a machine learning model.

At block 304, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to identify the sensitive information in the prompt.

At block 306, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to redact the sensitive information in the prompt to obtain a redacted prompt having redacted information removed from the prompt.

At block 308, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to transmitting the redacted prompt to the machine learning model.

In some aspects, the sensitive information can include one or more of personal identifiable information, protected health information or a category of information as defined by a user.

The method 300 can further include obtaining an output of the machine learning model based on the redacted prompt and introducing the redacted information into the output of the machine learning model to obtain a revised output.

The method 300 can further include detecting, via a topic modeling algorithm, the prompt to identify topical data in the prompt. The topic modeling algorithm can identify one or more of hate speech, bias or sexual content in the prompt.

In some aspects, the method 300 can further include redacting the topical data from the prompt to obtain a topic-redacted prompt.

In some aspects, the method 300 can further include transmitting, based on an identification of the sensitive information, a notice to a computing system.

In some aspects, a system for managing prompts to a machine learning model can include at least one memory; and at least one processor coupled to the at least one memory and configured to: receive a prompt having sensitive information, the prompt being received for input to a machine learning model; identify the sensitive information in the prompt; redact the sensitive information in the prompt to obtain a redacted prompt having redacted information removed from the prompt; and transmit the redacted prompt to the machine learning model.

FIG. 3B illustrates a method 320 for providing privacy-aware prompting to a machine learning model according to certain aspects of this disclosure. The method 320 can be practiced by a system or computing system such one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof.

At block 322, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to implement a pre-processing model to the machine learning model that processes a prompt to the machine learning model for privacy-related information.

At block 324, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to implementing a post-processing model that processes an output from the machine learning model.

The pre-processing model (i.e., the first private monitor 104A) processes the prompt to reduce sensitive information while maintaining a meaning of the prompt. The post-processing model processes the output of the machine learning model (i.e., the LLM 114) based on a first output from the pre-processing model and the output from the machine learning model.

The method 320 can further include communicating data from the pre-processing model to the post-processing model via a skip connection.

The method 320 can further include dynamically adjusting one or more of the pre-processing model or the post-processing model based on real-time human-in-the-loop feedback.

The method 320 can further include transmitting a notification to a computing device when sensitive information is detected in the prompt.

In some aspects, the pre-processing model and the post-processing model are built by applying model training to a network comprising the pre-processing model, the machine learning model and the post-processing model, with a loss function used in training calibrated to make the pre-processing model reduce sensitive information in the prompt and to make the network (i.e., the LLM 114) produce an output distribution similar to a standard output of the machine learning model without privacy-aware procedures.

In some aspects, a system for offering a secure model as a service can include at least one memory; and at least one processor coupled to the at least one memory and configured to: implement a pre-processing model to a target machine learning model that processes a prompt to the target machine learning model for privacy-related information; and implement a post-processing model that processes an output from the machine learning model.

FIG. 3C illustrates a method 340 for providing privacy-aware semantic searching according to certain aspects of this disclosure. The method 340 can be practiced by a system or computing system such one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof.

At block 342, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to receive a prompt to a target machine learning model (i.e., the LLM 114).

At block 344, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to generate, via a semantic search machine learning model (i.e., the embedding model 106), a sensitivity score for the prompt based on a relevant of the prompt to a sensitive enterprise data.

The sensitivity score can be integrated into a semantic search application.

In some aspects, the method 340 can further include dynamically adjusting the semantic search machine learning model based on real-time human-in-the-loop feedback.

The sensitivity score can influence a retrieval and presentation of enterprise data related to the prompt. The semantic search machine learning model can be trained specifically to identify sensitive or confidential information in the sensitive enterprise data.

In some aspects, the method 340 can further include transmitting a notification to a computing device when sensitive information, related to the sensitive enterprise data, is detected in the prompt.

In some aspects, the method 340 can further include modifying, based on the sensitivity score, the prompt to generate a modified prompt; and transmitting the modified prompt to the target machine learning model.

In some aspects, a system for providing privacy-aware semantic searching can include at least one memory; and at least one processor coupled to the at least one memory and configured to: receive a prompt to a target machine learning model; and generate, via a semantic search machine learning model, a sensitivity score for the prompt based on a relevant of the prompt to a sensitive enterprise data.

FIG. 3D illustrates a method 360 for providing privacy-aware semantic searching according to certain aspects of this disclosure. The method 360 can be practiced by a system or computing system such one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof.

At block 362, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to receive a prompt to a target machine learning model.

At block 364, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to identify sensitive information in the prompt.

At block 366, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to redact the sensitive information in the prompt.

At block 368, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to augment, via a semantic search-based retrieval model, the prompt with relevant enterprise data to generate a redacted and augmented prompt.

At block 370, a system (i.e., one or more of a computing system 400, a privacy monitor architecture 100, a first privacy monitor 104A, a second privacy monitor 104B, a third privacy monitor 104C, a knowledge source 102, an embedding model 106, a vector database 108, and a machine learning model such as LLM 114, a web interface 220 and/or any subcomponent or subsystem thereof) can and is configured to provide the redacted and augmented prompt to the target machine learning model.

The redacted and augmented prompt can be either redacted first or augmented first when generating the redacted and augmented prompt. The redacted and augmented prompt is configured to improve a relevancy and accuracy of a response by the target machine learning model (i.e., the LLM 114) without fine-tuning the target machine learning model. The prompt can be evaluated against an enterprise role-based access control system to evaluate whether a user who provided the prompt is authorized to generate prompts about corresponding enterprise documents, i.e., from the knowledge source 102.

The method can be performed by an automated detection model, a sandwich architecture around the target machine learning model, and a private semantic search model, operate both independently and in coordination.

The automated detection model, the sandwich architecture around the target machine learning model, and the private semantic search model operate either locally on enterprise hardware and systems, in a cloud environment, or with combination of other privacy enhancing technologies, such as inside trusted execution environments.

The method 360 can further include dynamically adjusting one or more of the automated detection model, the sandwich architecture around the target machine learning model, and the private semantic search model based on real-time human-in-the-loop feedback.

In some aspects, a system for providing an augmented, redacted prompt to a machine learning model can include at least one memory; and at least one processor coupled to the at least one memory and configured to: receive a prompt to a target machine learning model; identify sensitive information in the prompt; redact the sensitive information in the prompt; augment, via a semantic search-based retrieval model, the prompt with relevant enterprise data to generate a redacted and augmented prompt; and provide the redacted and augmented prompt to the target machine learning model.

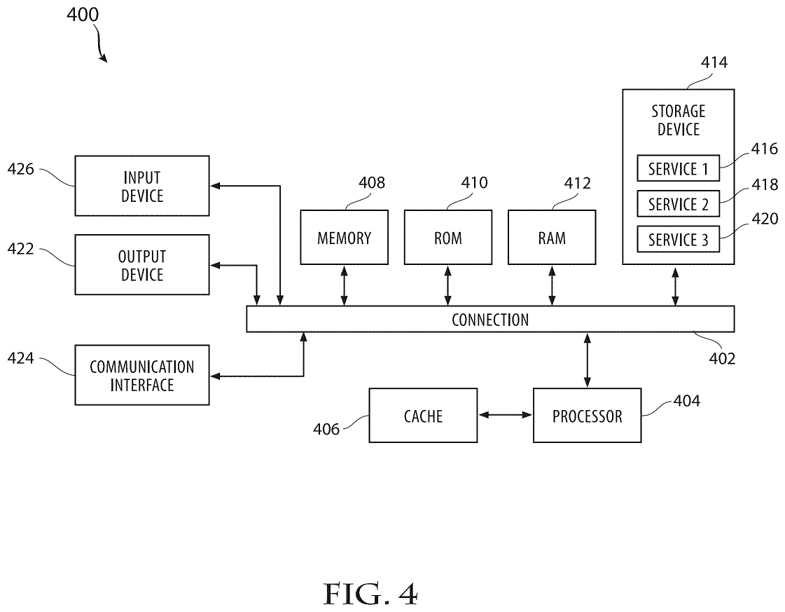

FIG. 4 shows an example of computing system 400, which can be for example any computing device making up any of the computing devices discussed herein or in the attached paper, or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit (CPU or processor) 404 and connection 402 that couples various system components including system memory 408, such as read-only memory (ROM) 410 and random access memory (RAM) 412 to processor 404. Computing system 400 can include a cache of high-speed memory 406 connected directly with, in close proximity to, or integrated as part of processor 404.

Processor 404 can include any general purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim clauses of this disclosure include the following clause sets. Claim clause set 1 relates to an automated detection and redaction approach for sensitive information. Claim clause set 2 relates to privacy-aware prompting using a sandwich approach. Claim clause set 3 relates to privacy-aware prompting using semantic search and enterprise information. Claim clause set 4 relates to an approach in which one or more of the above approaches are combined together.

### Claim Clause Set 1

Clause 1. A method of managing information provided to a machine learning model, the method comprising: receiving a prompt having sensitive information, the prompt being received for input to a machine learning model; identifying the sensitive information in the prompt; redacting the sensitive information in the prompt to obtain a redacted prompt having redacted information removed from the prompt; and transmitting the redacted prompt to the machine learning model.

Clause 2. The method of clause 1, wherein the sensitive information comprises one or more of personal identifiable information, protected health information or a category of information as defined by a user.

Clause 3. The method of clause 1, further comprising: obtaining an output of the machine learning model based on the redacted prompt; and introducing the redacted information into the output of the machine learning model to obtain a revised output.

Clause 4. The method of clause 1, further comprising: detecting, via a topic modeling algorithm, the prompt to identify topical data in the prompt.

Clause 5. The method of clause 4, further comprising: redacting the topical data from the prompt to obtain a topic-redacted prompt.

Clause 6. The method of clause 4, wherein the topic modeling algorithm identifies one or more of hate speech, bias or sexual content in the prompt.

Clause 7. The method of clause 1, further comprising: transmitting, based on an identification of the sensitive information, a notice to a computing system.

Clause 8. A system for managing prompts to a machine learning model, the system comprising: at least one memory; and at least one processor coupled to the at least one memory and configured to: receive a prompt having sensitive information, the prompt being received for input to a machine learning model; identify the sensitive information in the prompt; redact the sensitive information in the prompt to obtain a redacted prompt having redacted information removed from the prompt; and transmit the redacted prompt to the machine learning model.

Clause 9. The system of clause 8, wherein the sensitive information comprises one or more of personal identifiable information, protected health information or a category of information as defined by a user.

Clause 10. The system of clause 8, wherein the at least one processor coupled to the at least one memory and configured to: obtain an output of the machine learning model based on the redacted prompt; and introduce the redacted information into the output of the machine learning model to obtain a revised output.

Clause 11. The system of clause 8, wherein the at least one processor coupled to the at least one memory and configured to: detect, via a topic modeling algorithm, the prompt to identify topical data in the prompt.

Clause 12. The system of clause 11, wherein the at least one processor coupled to the at least one memory and configured to: redact the topical data from the prompt to obtain a topic-redacted prompt.

Clause 13. The system of clause 11, wherein the topic modeling algorithm identifies one or more of hate speech, bias or sexual content in the prompt.

Clause 14. The system of clause 8, wherein the at least one processor coupled to the at least one memory and configured to: transmit, based on an identification of the sensitive information, a notice to a computing system.

Clause 15. A non-transitory computer-readable medium having stored thereon instructions that, when executed by one or more processors, cause the one or more processors to: receive a prompt having sensitive information, the prompt being received for input to a machine learning model; identify the sensitive information in the prompt; redact the sensitive information in the prompt to obtain a redacted prompt having redacted information removed from the prompt; and transmit the redacted prompt to the machine learning model.

Clause 16. The non-transitory computer-readable medium of clause 15, wherein the sensitive information comprises one or more of personal identifiable information, protected health information or a category of information as defined by a user.

Clause 17. The non-transitory computer-readable medium of clause 15, further comprising the one or more processors being configured to: obtain an output of the machine learning model based on the redacted prompt; and introduce the redacted information into the output of the machine learning model to obtain a revised output.

Clause 18. The non-transitory computer-readable medium of clause 15, further comprising the one or more processors being configured to: detect, via a topic modeling algorithm, the prompt to identify topical data in the prompt.

Clause 19. The non-transitory computer-readable medium of clause 18, further comprising the one or more processors being configured to: redact the topical data from the prompt to obtain a topic-redacted prompt.

Clause 20. The non-transitory computer-readable medium of clause 18, wherein the topic modeling algorithm identifies one or more of hate speech, bias or sexual content in the prompt.

Clause 21. The transitory computer-readable medium of clause 14, further comprising the one or more processors being configured to: transmit, based on an identification of the sensitive information, a notice to a computing system.

### Claim Clause Set 2

Clause 1. A method of providing privacy-aware prompting to a machine learning model, the method comprising: implementing a pre-processing model to the machine learning model that processes a prompt to the machine learning model for privacy-related information; and implementing a post-processing model that processes an output from the machine learning model.

Clause 2. The method of clause 1, wherein the pre-processing model processes the prompt to reduce sensitive information while maintaining a meaning of the prompt.

Clause 3. The method of clause 1, wherein the post-processing model processes the output of the machine learning model based on a first output from the pre-processing model and the output from the machine learning model.

Clause 4. The method of clause 1, further comprising: communicating data from the pre-processing model to the post-processing model via a skip connection.

Clause 5. The method of clause 1, further comprising: dynamically adjusting one or more of the pre-processing model or the post-processing model based on real-time human-in-the-loop feedback.

Clause 6. The method of clause 1, further comprising: transmitting a notification to a computing device when sensitive information is detected in the prompt.

Clause 7. The method of clause 1, wherein the pre-processing model and the post-processing model are built by applying model training to a network comprising the pre-processing model, the machine learning model and the post-processing model, with a loss function used in training calibrated to make the pre-processing model reduce sensitive information in the prompt and to make the network produce an output distribution similar to a standard output of the machine learning model without privacy-aware procedures.

Clause 8. A system for offering a secure model as a service, the system comprising: at least one memory; and at least one processor coupled to the at least one memory and configured to: implement a pre-processing model to a target machine learning model that processes a prompt to the target machine learning model for privacy-related information; and implement a post-processing model that processes an output from the machine learning model.

Clause 9. The system of clause 8, wherein the pre-processing model processes the prompt to reduce sensitive information while maintaining a meaning of the prompt.

Clause 10. The system of clause 8, wherein the post-processing model processes the output of the machine learning model based on a first output from the pre-processing model and the output from the machine learning model.

Clause 11. The system of clause 8, wherein the at least one processor coupled to the at least one memory and configured to: communicate data from the pre-processing model to the post-processing model via a skip connection.

Clause 12. The system of clause 8, wherein the at least one processor coupled to the at least one memory and configured to: dynamically adjust one or more of the pre-processing model or the post-processing model based on real-time human-in-the-loop feedback.

Clause 13. The system of clause 8, wherein the at least one processor coupled to the at least one memory and configured to: transmit a notification to a computing device when sensitive information is detected in the prompt.

Clause 14. The system of clause 8, wherein the pre-processing model and the post-processing model are built by applying model training to a network comprising the pre-processing model, the target machine learning model and the post-processing model, with a loss function used in training calibrated to make the pre-processing model reduce sensitive information in the prompt and to make the network produce an output distribution similar to a standard output of the target machine learning model without privacy-aware procedures.

Clause 15. A non-transitory computer-readable medium having stored thereon instructions that, when executed by one or more processors, cause the one or more processors to: implement a pre-processing model to a target machine learning model that processes a prompt to the target machine learning model for privacy-related information; and implement a post-processing model that processes an output from the machine learning model.

Clause 16. The non-transitory computer-readable medium of clause 15, wherein the pre-processing model processes the prompt to reduce sensitive information while maintaining a meaning of the prompt.

Clause 17. The non-transitory computer-readable medium of clause 15, wherein the post-processing model processes the output of the machine learning model based on a first output from the pre-processing model and the output from the machine learning model.

Clause 18. The non-transitory computer-readable medium of clause 15, further comprising the one or more processors being configured to: communicate data from the pre-processing model to the post-processing model via a skip connection.

Clause 19. The non-transitory computer-readable medium of clause 15, further comprising the one or more processors being configured to: dynamically adjust one or more of the pre-processing model or the post-processing model based on real-time human-in-the-loop feedback.

Clause 20. The non-transitory computer-readable medium of clause 15, further comprising the one or more processors being configured to: transmit a notification to a computing device when sensitive information is detected in the prompt.

Clause 21. The non-transitory computer-readable medium of clause 15, wherein the pre-processing model and the post-processing model are built by applying model training to a network comprising the pre-processing model, the target machine learning model and the post-processing model, with a loss function used in training calibrated to make the pre-processing model reduce sensitive information in the prompt and to make the network produce an output distribution similar to a standard output of the target machine learning model without privacy-aware procedures.

Claim Clause Set 3

Clause 1. A method of providing privacy-aware semantic searching, the method comprising: receiving a prompt to a target machine learning model; and generating, via a semantic search machine learning model, a sensitivity score for the prompt based on a relevant of the prompt to a sensitive enterprise data.

Clause 2. The method of clause 1, wherein the sensitivity score is integrated into a semantic search application.

Clause 3. The method of clause 1, further comprising: dynamically adjusting the semantic search machine learning model based on real-time human-in-the-loop feedback.

Clause 4. The method of clause 1, wherein the sensitivity score influences a retrieval and presentation of enterprise data related to the prompt.

Clause 5. The method of clause 1, wherein the semantic search machine learning model is trained specifically to identify sensitive or confidential information in the sensitive enterprise data.

Clause 6. The method of clause 1, further comprising: transmitting a notification to a computing device when sensitive information, related to the sensitive enterprise data, is detected in the prompt.

Clause 7. The method of clause 1, further comprising: modifying, based on the sensitivity score, the prompt to generate a modified prompt; and transmitting the modified prompt to the target machine learning model.

Clause 8. A system for providing privacy-aware semantic searching, the system comprising: at least one memory; and at least one processor coupled to the at least one memory and configured to: receive a prompt to a target machine learning model; and generate, via a semantic search machine learning model, a sensitivity score for the prompt based on a relevant of the prompt to a sensitive enterprise data.

Clause 9. The system of clause 8, wherein the sensitivity score is integrated into a semantic search application.

Clause 10. The system of clause 8, further comprising the at least one processor being configured to: dynamically adjust the semantic search machine learning model based on real-time human-in-the-loop feedback.

Clause 11. The system of clause 8, wherein the sensitivity score influences a retrieval and presentation of enterprise data related to the prompt.

Clause 12. The system of clause 8, wherein the semantic search machine learning model is trained specifically to identify sensitive or confidential information in the sensitive enterprise data.

Clause 13. The system of clause 8, further comprising the at least one processor being configured to: transmit a notification to a computing device when sensitive information, related to the sensitive enterprise data, is detected in the prompt.

Clause 14. The system of clause 8, further comprising the at least one processor being configured to: modify, based on the sensitivity score, the prompt to generate a modified prompt; and transmit the modified prompt to the target machine learning model.

Clause 15. A non-transitory computer-readable medium having stored thereon instructions that, when executed by one or more processor, cause the one or more processor to: receive a prompt to a target machine learning model; and generate, via a semantic search machine learning model, a sensitivity score for the prompt based on a relevant of the prompt to a sensitive enterprise data.

Clause 16. The non-transitory computer-readable medium of clause 15, wherein the sensitivity score is integrated into a semantic search application.

Clause 17. The non-transitory computer-readable medium of clause 15, further comprising the one or more processor being configured to: dynamically adjust the semantic search machine learning model based on real-time human-in-the-loop feedback.

Clause 18. The non-transitory computer-readable medium of clause 15, wherein the sensitivity score influences a retrieval and presentation of enterprise data related to the prompt.

Clause 19. The non-transitory computer-readable medium of clause 15, wherein the semantic search machine learning model is trained specifically to identify sensitive or confidential information in the sensitive enterprise data.

Clause 20. The non-transitory computer-readable medium of clause 15, further comprising the one or more processor being configured to: transmit a notification to a computing device when sensitive information, related to the sensitive enterprise data, is detected in the prompt.

Clause 21. The non-transitory computer-readable medium of clause 15, further comprising the one or more processor being configured to: modify, based on the sensitivity score, the prompt to generate a modified prompt; and transmit the modified prompt to the target machine learning model.

Claim Clause Set 4

Clause 1. A method of providing an augmented, redacted prompt to a machine learning model, the method comprising: receiving a prompt to a target machine learning model; identifying sensitive information in the prompt; redacting the sensitive information in the prompt; augmenting, via a semantic search-based retrieval model, the prompt with relevant enterprise data to generate a redacted and augmented prompt; and providing the redacted and augmented prompt to the target machine learning model.

Clause 2. The method of clause 1, wherein the redacted and augmented prompt is either redacted first or augmented first when generating the redacted and augmented prompt.

Clause 3. The method of clause 1, wherein the redacted and augmented prompt improves a relevancy and accuracy of a response by the target machine learning model without fine-tuning the target machine learning model.

Clause 4. The method of clause 1 or claim 3, wherein the prompt is evaluated against an enterprise role-based access control system to evaluate whether a user who provided the prompt is authorized to generate prompts about corresponding enterprise documents.

Clause 5. The method of clause 1, wherein the method is performed by an automated detection model, a sandwich architecture around the target machine learning model, and a private semantic search model, operate both independently and in coordination.

Clause 6. The method of clause 5, wherein the automated detection model, the sandwich architecture around the target machine learning model, and the private semantic search model operate either locally on enterprise hardware and systems, in a cloud environment, or with combination of other privacy enhancing technologies, such as inside trusted execution environments.

Clause 7. The method of clause 6, further comprising: dynamically adjusting one or more of the automated detection model, the sandwich architecture around the target machine learning model, and the private semantic search model based on real-time human-in-the-loop feedback.

Clause 8. A system for providing an augmented, redacted prompt to a machine learning model, the system comprising: at least one memory; and at least one processor coupled to the at least one memory and configured to: receive a prompt to a target machine learning model; identify sensitive information in the prompt; redact the sensitive information in the prompt; augment, via a semantic search-based retrieval model, the prompt with relevant enterprise data to generate a redacted and augmented prompt; and provide the redacted and augmented prompt to the target machine learning model.

Clause 9. The system of clause 8, wherein the redacted and augmented prompt is either redacted first or augmented first when generating the redacted and augmented prompt.

Clause 10. The system of clause 8, wherein the redacted and augmented prompt improves a relevancy and accuracy of a response by the target machine learning model without fine-tuning the target machine learning model.

Clause 11. The system of clause 8 or claim 10, wherein the prompt is evaluated against an enterprise role-based access control system to evaluate whether a user who provided the prompt is authorized to generate prompts about corresponding enterprise documents.

Clause 12. The system of clause 8, wherein the at least one processor coupled to the at least one memory are configured to perform operations by an automated detection model, a sandwich architecture around the target machine learning model, and a private semantic search model, operate both independently and in coordination.

Clause 13. The system of clause 12, wherein the automated detection model, the sandwich architecture around the target machine learning model, and the private semantic search model operate either locally on enterprise hardware and systems, in a cloud environment, or with combination of other privacy enhancing technologies, such as inside trusted execution environments.

Clause 14. The system of clause 13, further comprising the at least one processor being configured to: dynamically adjust one or more of the automated detection model, the sandwich architecture around the target machine learning model, and the private semantic search model based on real-time human-in-the-loop feedback.

Clause 15. A non-transitory computer-readable medium having stored thereon instructions that, when executed by one or more processor, cause the one or more processor to: receive a prompt to a target machine learning model; identify sensitive information in the prompt; redact the sensitive information in the prompt; augment, via a semantic search-based retrieval model, the prompt with relevant enterprise data to generate a redacted and augmented prompt; and provide the redacted and augmented prompt to the target machine learning model.

Clause 16. The non-transitory computer-readable medium of clause 15, wherein the redacted and augmented prompt is either redacted first or augmented first when generating the redacted and augmented prompt.

Clause 17. The non-transitory computer-readable medium of clause 15, wherein the redacted and augmented prompt improves a relevancy and accuracy of a response by the target machine learning model without fine-tuning the target machine learning model.

Clause 18. The non-transitory computer-readable medium of clause 15 or claim 17, wherein the prompt is evaluated against an enterprise role-based access control system to evaluate whether a user who provided the prompt is authorized to generate prompts about corresponding enterprise documents.

Clause 19. The non-transitory computer-readable medium of clause 15, wherein the instructions cause the one or more processor to perform operations by an automated detection model, a sandwich architecture around the target machine learning model, and a private semantic search model, operate both independently and in coordination.

Clause 20. The non-transitory computer-readable medium of clause 19, wherein the automated detection model, the sandwich architecture around the target machine learning model, and the private semantic search model operate either locally on enterprise hardware and systems, in a cloud environment, or with combination of other privacy enhancing technologies, such as inside trusted execution environments.

Clause 21. The non-transitory computer-readable medium of clause 20, further comprising the one or more processor being configured to: dynamically adjust one or more of the automated detection model, the sandwich architecture around the target machine learning model, and the private semantic search model based on real-time human-in-the-loop feedback.

We claim:

1. A method of providing privacy-aware semantic searching, the method comprising:
receiving a prompt to a target machine learning model; and
generating, via a semantic search machine learning model, a sensitivity score for the prompt based on a relevant of the prompt to a sensitive enterprise data.

2. The method of claim 1, wherein the sensitivity score is integrated into a semantic search application.

3. The method of claim 1, further comprising:
dynamically adjusting the semantic search machine learning model based on real-time human-in-the-loop feedback.

4. The method of claim 1, wherein the sensitivity score influences a retrieval and presentation of enterprise data related to the prompt.

5. The method of claim 1, wherein the semantic search machine learning model is trained specifically to identify sensitive or confidential information in the sensitive enterprise data.

6. The method of claim 1, further comprising:
transmitting a notification to a computing device when sensitive information, related to the sensitive enterprise data, is detected in the prompt.

7. The method of claim 1, further comprising:
modifying, based on the sensitivity score, the prompt to generate a modified prompt; and
transmitting the modified prompt to the target machine learning model.

8. A system for providing privacy-aware semantic searching, the system comprising:
at least one memory; and
at least one processor coupled to the at least one memory and configured to:
receive a prompt to a target machine learning model; and
generate, via a semantic search machine learning model, a sensitivity score for the prompt based on a relevant of the prompt to a sensitive enterprise data.

9. The system of claim 8, wherein the sensitivity score is integrated into a semantic search application.

10. The system of claim 8, further comprising the at least one processor being configured to:
dynamically adjust the semantic search machine learning model based on real-time human-in-the-loop feedback.

11. The system of claim 8, wherein the sensitivity score influences a retrieval and presentation of enterprise data related to the prompt.

12. The system of claim 8, wherein the semantic search machine learning model is trained specifically to identify sensitive or confidential information in the sensitive enterprise data.

13. The system of claim 8, further comprising the at least one processor being configured to:
transmit a notification to a computing device when sensitive information, related to the sensitive enterprise data, is detected in the prompt.

14. The system of claim 8, further comprising the at least one processor being configured to:
modify, based on the sensitivity score, the prompt to generate a modified prompt; and
transmit the modified prompt to the target machine learning model.

15. A non-transitory computer-readable medium having stored thereon instructions that, when executed by one or more processor, cause the one or more processor to:
receive a prompt to a target machine learning model; and
generate, via a semantic search machine learning model, a sensitivity score for the prompt based on a relevant of the prompt to a sensitive enterprise data.

16. The non-transitory computer-readable medium of claim 15, wherein the sensitivity score is integrated into a semantic search application.

17. The non-transitory computer-readable medium of claim 15, further comprising the one or more processor being configured to:
dynamically adjust the semantic search machine learning model based on real-time human-in-the-loop feedback.

18. The non-transitory computer-readable medium of claim 15, wherein the sensitivity score influences a retrieval and presentation of enterprise data related to the prompt.

19. The non-transitory computer-readable medium of claim 15, wherein the semantic search machine learning model is trained specifically to identify sensitive or confidential information in the sensitive enterprise data.

20. The non-transitory computer-readable medium of claim 15, further comprising the one or more processor being configured to:
transmit a notification to a computing device when sensitive information, related to the sensitive enterprise data, is detected in the prompt.

21. The non-transitory computer-readable medium of claim 15, further comprising the one or more processor being configured to:
modify, based on the sensitivity score, the prompt to generate a modified prompt; and
transmit the modified prompt to the target machine learning model.
